(19) United States
(12) Patent Application Publication
(10) Pub. No.: US 2022/0003857 A1
(43) Pub. Date: Jan. 6, 2022

(54) METHOD AND SYSTEM TO IMPLEMENT WIDEBAND RETRO-REFLECTIVE WAVE MECHANICS

(71) Applicant: Mano Judd, Heath, TX (US)

(72) Inventor: Mano Judd, Heath, TX (US)

(21) Appl. No.: 16/920,526

(22) Filed: Jul. 3, 2020

(51) Int. Cl. G01S 13/06; G01S 15/06

(52) U.S. Cl. CPC G01S 13/06; G01S 15/06

(57) ABSTRACT

Methodology to combine Wave Mechanics with Retro-Reflection, to take in the Far Field emitted (incident) Wideband signal via a small array, process the signal and Retro-Reflectively re-transmits the Wideband signal back out, with the Wave Mechanics rotation mechanism injected into the array weights.

The present application claims priority to the earlier filed provisional application having Ser. No. 62/872,580, and hereby incorporates subject matter of the provisional application in its entirety.

### BACKGROUND

Retro-Reflection is defined as a process in which an incident signal is reflected back to the point of origin. In the Radio Frequency (RF) community, Retro-Reflective systems capture the incident RF signal energy and blindly re-transmit this signal. Radar Cross-Eye is one example of a Retro-Reflective System. The term blindly means that no source location or bearing angle information is required. Thus eliminating the need for a complex or expensive passive Direction Finding (DF) system to obtain the incident signal Angle of Arrival (AOA) or Direction of Arrival, and to compute a set of weights that would be used to transmit a copy of the signal back towards the incident signal direction (path). For most Retro-Reflection systems, the output weight vector or steering vector is simply the complex conjugate of the incident signal steering vector. Therefore, one only needs to obtain a course estimate for the incident signal steering vector to construct the conjugate re-transmit steering vector. This can be accomplished simply by collecting a few (array vector) signal samples, and processing them to obtain an estimate of the incident signal steering vector. No further directional processing is then required, and computing the conjugate of the incident signal steering vector is thus trivial.

In patent application Ser. No. 15/934,563 the Inventor describes a technology and methodology to rotate near field and far field wave fronts, such that the effective transmitted wave front at a point or region in space is not propagating in a direction orthogonal to the direction of travel. This technology is termed “Wave Mechanics” (WM). An RF (or acoustic) array is used to produce a set of transmitted signals, such when these signals constructively and destructively interfere in the far field, the effective wave front is rotated such that in-phase crests and troughs of the wave impinge on target in a pre-determined and calculated direction, that is not orthogonal to the natural expanding path of the wave front.

The “Single Ship” WM model is defined as when all antennas in the array are co-located on a single ship, platform, or compact system. The primary issue with co-location of all antennas within a small area is that the effective size or width of the wave mechanics resultant (width of the expanding wave front in the far field) becomes narrower as the desired rotation angle is increased and as range is increased. In fact, the effective width of this wave field is approximately on the order of the size of the transmit array itself.

In Provisional Patent Application 62/872,446, the Inventor describes a narrowband solution to the Single Ship problem, to combine Wave Mechanics with Retro-Reflection. Thus, the implementation takes in the narrowband Far Field emitted signal via numerous “Single Ship” antennas (e.g. the array), processes the narrowband signal and Retro-Reflectively re-transmits the signal back out, with the Wave Mechanics rotation mechanism injected into the array weights. The Wave Mechanics implementation of this results in a pre-determined wavefront rotation, as well as much higher received power (at the original emitter), as compared to Cross-Eye that does not generate a controlled rotated wave and requires much higher transmitter power levels. In applying this method, we can overcome the error of the limited Wave Mechanics (Single Ship) wavefront width or corridor.

For the narrowband Single Ship solution, it can be shown that for the very Far Field, that the Electric Field value at the designated points tend to be highly similar in value, independent of the chosen weights. In Ray Theory, this would be discussed as the highly ill-conditioned state where the various Rays tend to be almost perfectly parallel to one another. For single ship solutions, however, for example a large aircraft solution, where sub-arrays can be installed at the wing ends, there is likely sufficient angle differences, within processing error margin, to enable far field rotations with operationally effective rotation angles, from a single ship.

This issue can be overcome by generating two or more sub-arrays, that are spaced roughly 2 percent or the range or greater (dual ship or multi-ship models). When this is done, the width of the wave field is literally on the order of the range itself. However, the cost is in the requirement of two or more independent systems, that are also coherently synchronized.

However, the desire for a wideband signal single ship solution, with large range, on the order or 100 to 500 nautical miles (nmiles) or greater is still highly desired for much smaller platforms, including fighter jets and even small Unmanned Aerial Vehicles (UAVs). The problem is how to accurately and cost effectively project the Wave Mechanics phenomenon at great range, but also to such a small width.

### BRIEF SUMMARY OF THE INVENTION

The Inventor's solution is to combine Wave Mechanics with Retro-Reflection, with the full wideband signal spectrum broken up into Discrete Fourier Transform (DFT) frequency binning. Each frequency bin is then treated as an independent narrowband signal model, and the weight vector for each bin is solved for. Finally, all the different and independent frequency weights are Inverse Fourier Transformed (IDFT) back to the time domain, resulting in a time domain signal already weighted. Thus, the implementation takes in the Far Field emitted wideband signal via numerous “Single Ship” antennas (e.g. the array), processes the wideband signal and Retro-Reflectively re-transmits the wideband signal back out, with the Wave Mechanics rotation mechanism injected into the array weights. The Wave Mechanics implementation of this results in a pre-determined wavefront rotation across the full wide band frequency range, as well as much higher received power (at the original emitter), as compared to Cross-Eye that does not generate a controlled rotated wave and requires much higher transmitter power levels. In applying this method, we can overcome the error of the limited Wave Mechanics (Single Ship) wavefront width or corridor.

This Wideband Retro-Reflective WM solution requires no estimation or computation of the incident signal Angle of Arrival (AOA), and is effectively blind.

The novelty is using a captured estimate of the incident steering vector, and using each weight to construct the Rf matrix for each frequency bin, and for a given desired rotation angle. The Rf matrix, on for each bin, is then used to compute a set of transmit weights, also one set of weight for each bin, and Inverse FFT the resultant to obtain the time domain weights that will produce the rotation angle, with an unknown incident signal angle.

### BRIEF DESCRIPTION OF THE DRAWINGS

FIG. 1 shows M antennas in a linear array, spaced by d.

FIG. 2 illustrates Source antennas and Far Field Points

FIG. 3 shows a System using RF Circulators.

FIG. 4 illustrates a System using RF Switches.

### DETAILED DESCRIPTION AND BEST MODE OF IMPLEMENTATION

First, we review the Narrowband Retro-Reflective Wave Mechanics technique:

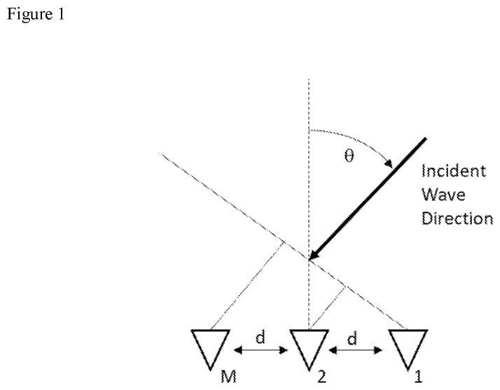

FIG. 1 shows M antennas in a linear array, spaced by d. Assume M antennas. The m^{th} component (m=1, 2, . . . , M) of the steering vector can be represented as:

aₘ=Gₘ(θ)exp^{-j·(m-1)·k·d·sin(θ}^{ᵢ}⁾

Where:

Gₘ(θ)=the antenna voltage of the m^{th} antenna, in the θ direction

K=wave number=2π/λ

d=sensor to sensor spacing, assumed equal in this model.

θᵢ=Incident signal direction of arrival, to the line normal to the array.

This m^{th} component of the steering vector can also be represented as a function of frequency or simply an electrical phase:

$$\begin{matrix}{a}_{m} = {G}_{m} ( {θθ}_{i} ) {exp}^{- j \cdot ( m - 1 ) \cdot ( ω \text{/} c ) \cdot d \cdot sin ( {θ}_{i} )} \\ = {G}_{m} ( {θ}_{i} ) {exp}^{- j \cdot {ϕ}_{m}}\end{matrix}$$

Where:

ω=radial frequency, and

c=speed of light, and

ϕₘ=phase of the m^{th} antenna, relative to a common reference phase

For this simplistic model, the sensor to sensor spacing(s) are equal.

Assume also, for this simplified model, that the antenna gains are equivalent from sensor to sensor, such that:

Gₘ(θᵢ)=G(θᵢ) for all m=1,2, . . . ,M.

Therefore, the Array Factor, for the received signal, can be expressed as:

$$\begin{matrix}{AF}_{rec} ( {θ}_{i} ) = {\sum }_{m = 1}^{M} {A}_{m} \cdot {G}_{m} ( {θ}_{i} ) \cdot {exp}^{- j \cdot ( m - 1 ) \cdot k \cdot d \cdot sin ( {θ}_{i} )} \\ = G ( {θ}_{i} ) {\sum }_{m = 1}^{M} {A}_{m} \cdot {exp}^{- j \cdot ( m - 1 ) \cdot k \cdot d \cdot sin ( {θ}_{i} )}\end{matrix}$$

And the Array factor for the reverse transmitted signal can be expressed as:

$$\begin{matrix}{AF}_{transmit} ( {θ}_{o} ) = {\sum }_{m = 1}^{M} {B}_{m} \cdot {G}_{m} ( {θ}_{o} ) \cdot {exp}^{- j \cdot ( m - 1 ) \cdot k \cdot d \cdot sin ( {θ}_{o} )} \\ = G ( {θ}_{o} ) {\sum }_{m = 1}^{M} {B}_{m} \cdot {exp}^{- j \cdot ( m - 1 ) \cdot k \cdot d \cdot sin ( {θ}_{o} )}\end{matrix}$$

Where

Bₘ=the output signal for antenna m

Therefore, to coherently sum in the far field, in the same direction as the receive signal,

Bₘ=G(θᵢ)·exp^{+j·(m-1)·k·d·sin(θ}^{ᵢ}⁾

Therefore, for this coherent summation, θᵢ=θₒ

$$\begin{matrix}{AF}_{transmit} ( {θ}_{i} = {θ}_{o} ) = & G ( {θ}_{o} ) {\sum }_{m = 1}^{M} G ( {θ}_{o} ) \cdot {exp}^{+ j \cdot ( m - 1 ) \cdot k \cdot d \cdot sin ( {θ}_{o} )} \cdot \\ & {exp}^{- j \cdot ( m - 1 ) \cdot k \cdot d \cdot sin ( {θ}_{o} )} \\ = & {G}^{2} ( {θ}_{o} ) {\sum }_{m = 1}^{M} {exp}^{+ j \cdot ( 0 )} \\ = & M \cdot {G}^{2} ( {θ}_{o} )\end{matrix}$$

Note that the incident phase and the output phases are related by:

ϕₒ=−ϕᵢ=−ϕₒ=conjugate(ϕₒ)

Or that the two phases are simply conjugates of one another. Thus a Retro-Reflective output signal is simply steered with the conjugate of the incident signal steering vector.

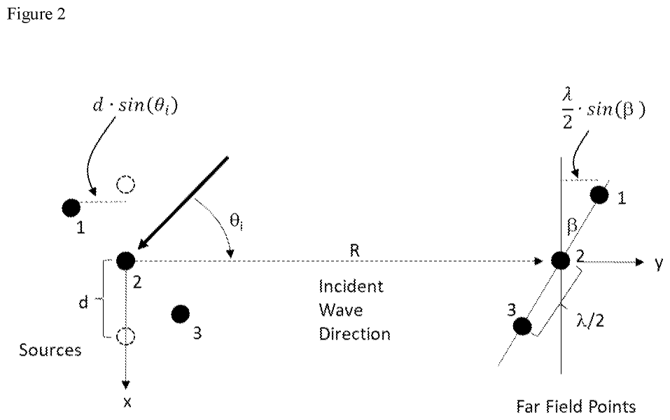

The diagram in FIG. 2 shows three (M=3) source antennas and three (N=3) Far file points. Without loss of generality, the number of sources can be any number, M, and the number of Far-Field points can be any number, N. The incident signal direction, from the middle (center point) antenna in the Far Field is θᵢ. Thus, with the narrowband steering vector for the three antennas can be represented as:

$$a ( {θ}_{i} ) = [ \begin{matrix}{exp}^{+ j ( 1 ) \cdot k \cdot d \cdot sin [ {θ}_{i} ]} \\ {exp}^{+ j ( 0 ) \cdot k \cdot d \cdot sin [ {θ}_{i} ]} \\ {exp}^{- j ( 1 ) \cdot k \cdot d \cdot sin [ {θ}_{i} ]}\end{matrix} ]$$

Again, it should be noted that the following example is only using M=3 sources and N=M=3 Far-Field points. However, this method can be utilized for any M and N.

This steering vector is easily obtained with the collection of a few data samples (array snapshots), especially for relatively high SNR signals.

A simple narrowband Retro-Reflective signal can therefore be produced by transmitting the incident signal, s(t), back with steering weights of conjugate [a(θᵢ)].

We are interested in generating a Retro-Reflective Wave Mechanics signal, that would be transmitted from each of the three source antennas. Furthermore, we would want this to be a blind function, that would not require Directing Finding or determination of the Incident Signal Direction, θᵢ. One of the benefits of this approach is that the computation of the required weights, and injection of these weights into a transmitted Retro-Reflective signal could occur in microseconds, with the DSP architecture developing into a custom FPGA module.

Recall that the narrowband form of the Wave Mechanics solution, for M transmit antennas and N Far-Field points, is:

$$( s ( t ) {e}^{( j ω t )} ) [ \begin{matrix}\frac{1}{{r}_{11}} {e}^{{jkr}_{11}} & \frac{1}{{r}_{12}} {e}^{{jkr}_{12}} & … & \frac{1}{{r}_{1 M}} {e}^{{jkr}_{1 M}} \\ \frac{1}{{r}_{21}} {e}^{{jkr}_{21}} & \frac{1}{{r}_{22}} {e}^{{jkr}_{22}} & … & \frac{1}{{r}_{2 M}} {e}^{{jkr}_{2 M}} \\ \frac{1}{{r}_{M 1}} {e}^{{jkr}_{M 1}} & \frac{1}{{r}_{M 2}} {e}^{{jkr}_{M 2}} & … & \frac{1}{{r}_{MM}} {e}^{{jkr}_{MM}}\end{matrix} ] [ \begin{matrix}{h}_{1} \\ {h}_{2} \\ ⋮ \\ {h}_{M}\end{matrix} ] = ( s ( t ) {e}^{( j ω t )} ) [ \begin{matrix}{V}_{1} \\ {V}_{2} \\ ⋮ \\ {V}_{M}\end{matrix} ]$$

Where each rₙₘ in the matrix is simply the distance from a Far Field point n, to the source antenna m.

The more compact form of this expression is:

$$\frac{1}{r} [ \begin{matrix}{e}^{{jkr}_{11}} & {e}^{{jkr}_{12}} & … & {e}^{{jkr}_{1 M}} \\ {e}^{{jkr}_{21}} & {e}^{{jkr}_{22}} & … & {e}^{{jkr}_{2 M}} \\ {e}^{{jkr}_{M 1}} & {e}^{{jkr}_{M 2}} & … & {e}^{{jkr}_{MM}}\end{matrix} ] [ \begin{matrix}{h}_{1} \\ {h}_{2} \\ ⋮ \\ {h}_{M}\end{matrix} ] = [ \begin{matrix}{V}_{1} \\ {V}_{2} \\ ⋮ \\ {V}_{M}\end{matrix} ]$$

Where for rₙₘ large, then rₙₘ≈r.

Neglecting the 1/r term as a constant, this can be represented as:

Rₓₓh=V

The key is to estimate the rₙₘ components, in a blind fashion, for a desired Wave rotation angle of β.

Note that in [00059] that N=M has been used. However, in general, Rₓₓ can be a N×M matrix, and V would then be a N×1 vector.

The primary approximation to use in the development, is to assume that for a given source spacing d, or Far Field point separation λ/2, that the y-component of the effective distance will be much much larger than the x-component. In general, the Far Field point separation will be less than or equal to λ/2 to reduce spatial aliasing.

For example, the distance from source antenna #1 to Far-Field Point #1 can be estimated as:

r₁₁=\sqrt{[d·sin(θᵢ)+R+(λ/2)·sin(β)]²+[d−λ/2]²}

We can see that when R>>d−λ/2 that:

r₁₁≈d·sin(θᵢ)+R+(λ/2)·sin(β)

Using similar reasoning, we can observe that:

r₁₂≈0+R+(λ/2)·sin(β)

r₁₃≈d·sin(θᵢ)+R+(λ/2)·sin(β)

Therefore, the first row of the narrowband implementation of Rxx would be:

$${\underline{a} ( {θ}_{i} )}_{point 1} = {{exp}^{k \cdot R \cdot sin [ {θ}_{i} ]} [ \begin{matrix}{exp}^{+ j ( 1 ) \cdot k \cdot d \cdot sin [ {θ}_{i} ]} \cdot {exp}^{+ j ( 1 ) \cdot k \cdot ( λ \text{/} 2 ) \cdot sin [ β ]} \\ {exp}^{+ j ( 0 ) \cdot k \cdot d \cdot sin [ {θ}_{i} ]} \cdot {exp}^{+ j ( 1 ) \cdot k \cdot ( λ \text{/} 2 ) \cdot sin [ β ]} \\ {exp}^{- j ( 1 ) \cdot k \cdot d \cdot sin [ {θ}_{i} ]} \cdot {exp}^{+ j ( 1 ) \cdot k \cdot ( λ \text{/} 2 ) \cdot sin [ β ]}\end{matrix} ]}^{T}$$

Which is an M×1 vector. Notice the transpose “T”.

It should be noted that for [00053], the first antenna is selected as the reference antenna, where-as in [00077], the middle antenna is selected as the reference antenna. Additionally, in [00077], the first column of delays (complex exponentials) have already been conjugated to produce beamformed transmit outputs, aligned with the incident signal. Thus, it should be noted that the left side column of complex exponentials in [00077] can be easily computed from [00053]. The right side column, which includes the complex exponentials in rotation angle, are easily computed from the known incident signal wavelength, λ, as well as the desired rotation angle, β.

Therefore, another means to implement this would simply be to conjugate the terms in [00053], and use them directly in [00077] for the left side column.

Similarly,

r₂₁≈d·sin(θᵢ)+R+(0)·sin(β)

r₂₂≈0·d·sin(θ₁)+R+(0)·sin(β)

r₂₃≈−d·sin(θ₁)+R+(0)·sin(β)

Therefore, the second row of the narrowband implementation of Rxx would be:

$${\underline{a} ( {θ}_{i} )}_{point 2} = {{exp}^{k \cdot R \cdot sin [ {θ}_{i} ]} [ \begin{matrix}{exp}^{+ j ( 1 ) \cdot k \cdot d \cdot sin [ {θ}_{i} ]} \cdot {exp}^{+ j ( 1 ) \cdot k \cdot ( 0 ) \cdot sin [ β ]} \\ {exp}^{+ j ( 0 ) \cdot k \cdot d \cdot sin [ {θ}_{i} ]} \cdot {exp}^{+ j ( 1 ) \cdot k \cdot ( 0 ) \cdot sin [ β ]} \\ {exp}^{- j ( 1 ) \cdot k \cdot d \cdot sin [ {θ}_{i} ]} \cdot {exp}^{+ j ( 1 ) \cdot k \cdot ( 0 ) \cdot sin [ β ]}\end{matrix} ]}^{T}$$

Finally,

r₃₁≈d·sin(θᵢ)+R−(λ/2)·sin(β)

r₃₂≈0·d·sin(θᵢ)+R−(λ/2)·sin(β)

r₃₃≈−d·sin(θᵢ)+R−(λ/2)·sin(β)

Therefore, the third row of the narrowband implementation of Rxx would be:

$${\underline{a} ( {θ}_{i} )}_{point 3} = {{exp}^{k \cdot R \cdot sin [ {θ}_{i} ]} [ \begin{matrix}{exp}^{+ j ( 1 ) \cdot k \cdot d \cdot sin [ {θ}_{i} ]} \cdot {exp}^{- j ( 1 ) \cdot k \cdot ( λ \text{/} 2 ) \cdot sin [ β ]} \\ {exp}^{+ j ( 0 ) \cdot k \cdot d \cdot sin [ {θ}_{i} ]} \cdot {exp}^{- j ( 1 ) \cdot k \cdot ( λ \text{/} 2 ) \cdot sin [ β ]} \\ {exp}^{- j ( 1 ) \cdot k \cdot d \cdot sin [ {θ}_{i} ]} \cdot {exp}^{- j ( 1 ) \cdot k \cdot ( λ \text{/} 2 ) \cdot sin [ β ]}\end{matrix} ]}^{T}$$

We can now approximate the Rxx matrix as:

$$Rxx = [ \begin{matrix}{\underline{a} ( {θ}_{i} )}_{point 1} \\ {\underline{a} ( {θ}_{i} )}_{point 2} \\ {\underline{a} ( {θ}_{i} )}_{point 3}\end{matrix} ]$$

It should noted that from the original narrowband incident steering vector:

$$a ( {θ}_{i} ) = [ \begin{matrix}{exp}^{+ j ( 1 ) \cdot k \cdot d \cdot sin [ {θ}_{i} ]} \\ {exp}^{+ j ( 0 ) \cdot k \cdot d \cdot sin [ {θ}_{i} ]} \\ {exp}^{- j ( 1 ) \cdot k \cdot d \cdot sin [ {θ}_{i} ]}\end{matrix} ]$$

which has been numerically estimated, a known incident signal carrier frequency, and desired Rotation angle, β, that the narrowband Rxx matrix can be quickly and accurately computed.

Finally, we solve for the narrowband model as:

Rₓₓh=V

Via a direct matrix inversion, as:

h=Rxx⁻¹V

Or via the use a Genetic Algorithm.

Note that for the case of a desired rotated plane wave, that

$$\underline{V} = [ \begin{matrix}1 \\ 1 \\ 1\end{matrix} ]$$

That is, the far field desired voltage (or field) response is the same for each Far-Field point.

Wideband Mechanism for Retro-Reflective Wave Mechanics

The previous model (Provisional Patent No. 62/872,446) is likely sufficient for narrowband signals only. That is, when the bandwidth of the incident signal is much less than 1/100th of the carrier frequency.

Assume now that the incident signal is a wideband signal, s(t), that we want to replicate and conjugate, to feed into each antenna in the source array. As with the prior [narrowband signal model] method, we will want this signal to form an output, represented by:

output=h(t)·s(t)

The incident signal, s(t), can be sampled from a single antenna and separated into a collection of Frequency domain samples via conversion through a [complex] Discrete Fourier Transform (DFT). Each of the Frequency domain samples can be represented as:

$${S}_{f} = {\sum }_{n = ∅}^{N - 1} {s}_{n} {e}^{- j \frac{2 π fn}{N}}$$

Where:

n≡index of data samples (or the sample number in time)

N≡number of samples per DFT

f≡frequency index (integer), or the frequency of each [complex] DFT spectral bin.

Sampling of the signal, within each frequency bin for all the antennas, however, would result in:

$${S}_{f} \cdot \underline{a} ( {θ}_{i} , f + {f}_{c} ) = {\sum }_{n = ∅}^{N - 1} {\underline{s}}_{n} {e}^{- j \frac{2 π fn}{N}}$$

Thus similar to [00053], we obtain a steering vector, a(θᵢ, f+f_{c}, for each frequency bin, that is both a function of the incident signal angle of arrival as well as the frequency of the bin. It should be noted that these delays will be a function of the carrier frequency, f_{c}, thus the frequency f needs to be denoted not only as the discrete frequency of the baseband frequency bin, but also to account for any frequency shifting in the down conversion process. The steering vector for incident angle θᵢ and carrier frequency f_{c} can be represented for each bin, f, as:

$$\underline{a} ( {θ}_{i} , f + {f}_{c} ) = [ \begin{matrix}{exp}^{+ j ( 1 ) \cdot {k}_{c} \cdot d \cdot sin [ {θ}_{i} ]} \\ {exp}^{+ j ( 0 ) \cdot {k}_{c} \cdot d \cdot sin [ {θ}_{i} ]} \\ {exp}^{- j ( 1 ) \cdot {k}_{c} \cdot d \cdot sin [ {θ}_{i} ]}\end{matrix} ]$$

It should be noted that the wavenumber value k, in the exponent, is now represented by:

$${k}_{c} = \frac{2 \cdot π}{{λ}_{c}}$$

$$and$$

$${λ}_{c} = \frac{c}{f + {f}_{c}}$$

We can now build the Wave Mechanics steering vectors for the wideband model, for each [frequency] bin, similar to the how the vectors were built in the narrowband model. That is, for each bin, f=1, 2, . . . , N, we compute the vectors:

$${\underline{a} ( {θ}_{i} , f + {f}_{c} )}_{point 1} = {{exp}^{k \cdot R \cdot sin [ {θ}_{i} ]} [ \begin{matrix}{exp}^{+ j ( 1 ) \cdot {k}_{c} \cdot d \cdot sin [ {θ}_{i} ]} \cdot {exp}^{+ j ( 1 ) \cdot {k}_{c} \cdot ( {λ}_{c} \text{/} 2 ) \cdot sin [ β ]} \\ {exp}^{+ j ( 0 ) \cdot {k}_{c} \cdot d \cdot sin [ {θ}_{i} ]} \cdot {exp}^{+ j ( 1 ) \cdot {k}_{c} \cdot ( {λ}_{c} \text{/} 2 ) \cdot sin [ β ]} \\ {exp}^{- j ( 1 ) \cdot {k}_{c} \cdot d \cdot sin [ {θ}_{i} ]} \cdot {exp}^{+ j ( 1 ) \cdot {k}_{c} \cdot ( {λ}_{c} \text{/} 2 ) \cdot sin [ β ]}\end{matrix} ]}^{T} \\ {\underline{a} ( {θ}_{i} , f + {f}_{c} )}_{point 2} = {{exp}^{k \cdot R \cdot sin [ {θ}_{i} ]} [ \begin{matrix}{exp}^{+ j ( 1 ) \cdot {k}_{c} \cdot d \cdot sin [ {θ}_{i} ]} \cdot {exp}^{+ j ( 1 ) \cdot {k}_{c} \cdot ( 0 ) \cdot sin [ β ]} \\ {exp}^{+ j ( 0 ) \cdot {k}_{c} \cdot d \cdot sin [ {θ}_{i} ]} \cdot {exp}^{+ j ( 1 ) \cdot {k}_{c} \cdot ( 0 ) \cdot sin [ β ]} \\ {exp}^{- j ( 1 ) \cdot {k}_{c} \cdot d \cdot sin [ {θ}_{i} ]} \cdot {exp}^{+ j ( 1 ) \cdot {k}_{c} \cdot ( 0 ) \cdot sin [ β ]}\end{matrix} ]}^{T} \\ {\underline{a} ( {θ}_{i} , f + {f}_{c} )}_{point 3} = {{exp}^{k \cdot R \cdot sin [ {θ}_{i} ]} [ \begin{matrix}{exp}^{+ j ( 1 ) \cdot {k}_{c} \cdot d \cdot sin [ {θ}_{i} ]} \cdot {exp}^{- j ( 1 ) \cdot {k}_{c} \cdot ( {λ}_{c} \text{/} 2 ) \cdot sin [ β ]} \\ {exp}^{+ j ( 0 ) \cdot {k}_{c} \cdot d \cdot sin [ {θ}_{i} ]} \cdot {exp}^{- j ( 1 ) \cdot {k}_{c} \cdot ( {λ}_{c} \text{/} 2 ) \cdot sin [ β ]} \\ {exp}^{- j ( 1 ) \cdot {k}_{c} \cdot d \cdot sin [ {θ}_{i} ]} \cdot {exp}^{- j ( 1 ) \cdot {k}_{c} \cdot ( {λ}_{c} \text{/} 2 ) \cdot sin [ β ]}\end{matrix} ]}^{T}$$

Where β is the desired rotation angle, and f_{c} is the carrier frequency shift. Note also, that the transposed vectors are of dimension 1×M, where “T” is the transpose operator.

We can now approximate a Rₓₓ matrix, for each frequency bin, as:

$${R}_{xx} ( {θ}_{i} , f + {f}_{c} ) = [ \begin{matrix}{\underline{a} ( {θ}_{{θ}_{i}} , f + {f}_{c} )}_{point 1} \\ {\underline{a} ( {θ}_{i} , f + {f}_{c} )}_{point 2} \\ {\underline{a} ( {θ}_{i} , f + {f}_{c} )}_{point 3}\end{matrix} ]$$

Next, we solve for the weights vectors, h_{f}, for each bin, using:

Rₓₓ(θᵢ,f+f_{c})h_{f}=V_{f}

Note that for the case of a desired rotated plane wave, that

$${\underline{V}}_{f} = [ \begin{matrix}1 \\ 1 \\ 1\end{matrix} ]$$

For all frequency bins.

That is, the far field desired voltage (or field) response is the same for each Far-Field point.

We can now solve the weights, for each [frequency] bin, f=1, 2, . . . , N, via a direct matrix inversion, as:

h_{f}=Rₓₓ(θᵢ,f+f_{c})⁻¹V_{f}

Or via the use a Genetic Algorithm.

We now reconstruct the desired output signal, to be fed into the RF Upconverter, as:

$${\underline{W}}_{n} = \frac{1}{N} {\sum }_{f = 0}^{N - 1} {\underline{h}}_{f} {S}_{f} {e}^{+ \frac{2 π fn}{N}}$$

Notice that Wₙ is the Inverse DFT for the wideband signal output, fully weighted across all frequencies, which is then output to the same antennas, as [00074]. The discrete frequency response, for the time series analog signal s(t), S_{f}, is now multiplied at each frequency Bin by the spectral Bin weights, h_{f}, to obtain the Inverse DFT, which is again back in the time domain. This is the output, from the Processing (FPGAs) which would be sent to the transmitter (multi-Channel) exciters.

System Implementation:

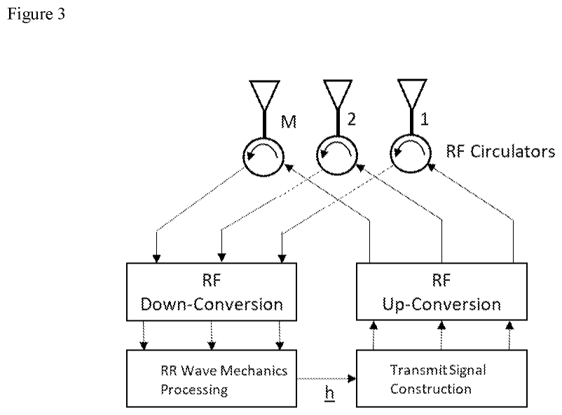

The system in FIG. 3 shows one embodiment of an RF plus digital system that could implement the mechanism described in [000109] through [000141]. Shown are three antennas that perform both the transmit and receive functionality. Note that without loss of generality, this mechanism applies to any number of source antennas, M, and any number of Far Field points, N. The Incident signal is received through these sensors, and passed through RF Circulators, which are 3-port devices that provide high levels of isolation between RF ports. For example, the port, on each circulator, that attaches to the RF Downconverter path, is highly isolated from the port attached to the RF Upconverter path.

It is assumed that the signals from each of the M antennas, in the RF Downconvert path (shown on the left) are coherently frequency shifted to baseband, that RetroReflective (RR) Wave Mechanics Processor will compute an estimated wideband receive steering vectors [000125] through [000127] for each frequency bin, the wideband Rₓₓ Matrices [000130] for each frequency bin, and finally solve for an optimal set of weights h_{f}, for each frequency bin [000138]. These weights are then sent to the waveform generator, multiplied and form the Transmit Signal Construction stage. These digital signals are then passed through a Digital to Analog (DAC) Converter and RF upconverted (frequency shifted), and finally re-transmitted out the same antennas.

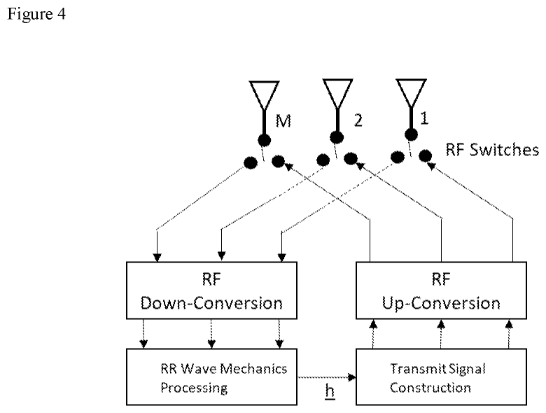

Another embodiment of the invention would include the use of RF Switches, shown in FIG. 4.

Both embodiments function to receive the incident signal, quickly compute the received steering weights (vector), conjugate the weights, multiply by the complex rotation exponentials, and use the resulting matrix to compute a set of transmit weight, h_{f}, used to send a rotation signal back to the original source.

### REFERENCES (INCORPORATED HEREIN BY REFERENCE)

Judd, M. (2018) U.S. patent application Ser. No. 15/934,563
Judd, M. (2019) U.S. Provisional Patent Application No. 62/872,446

What is claimed is:

1. A method to combine wave mechanics, patent application Ser. No. 15/934,563 and wideband wave mechanics, patent application Ser. No. 16/918,017, with retro-reflection wave mechanics, patent Ser. No. 16/918,133, wherein
a time domain signal for transmission is generated and input into each antenna channel in a phased array system,
a wideband incident signal to the array is blindly reflected back to a far field point of origin with a desired wave mechanics wave front rotation angle; and
the effective wideband transmitted wave front at a point or region in space is not propagating in a direction orthogonal to the direction of travel of the reflected wave.

2. The method of claim 1 which takes in the far field emitted wideband signal via a multiplicity of antennas in an array and then processes the signal and retro-reflectively re-transmits the wideband signal back out with the wave mechanics rotation mechanism injected into the array weights.

3. The method of claim 1 that uses a captured estimate of the incident steering vector from a source with an unknown incident signal bearing angle and utilizes each steering vector weight to construct an R-matrix for a user-defined wave mechanics rotation angle wherein the R-matrix is then used to compute a set of transmit weights for the re-transmitted wideband signal from the array which will produce the desired far field rotation angle.

4. The method of claim 1 which combines wave mechanics with retro-reflection, with the full wideband signal spectrum broken up into Discrete Fourier Transform (DFT) frequency binning wherein each frequency bin is then treated as an independent narrowband signal model and the weight vector for each bin is solved for, and then all the different and independent frequency weights are Inverse Fourier Transformed (IDFT) back to the time domain, resulting in a time domain signal already weighted.

5. The method of claim 1 wherein a captured estimate of incident steering vectors for each frequency bin is used with each weight to construct the Rf matrix for each frequency bin, and for a given desired rotation angle, the Rf matrix for each bin, is then used to compute a set of transmit weights, also one set of weights for each bin, and the resultant is inverse fast Fourier transformed to obtain the time domain weights that will produce the rotation angle, with an unknown incident signal angle.

6. The method of claim 1 wherein the rₙₘ components for the R-Matrix, in each frequency bin, are estimated in a blind fashion for any desired Wave rotation angle of β, N is the number of far field wavefield points, and M is the number of antennas in the array.

7. The method of claim 1 wherein the collected steering vector, for each frequency bin, is conjugated, and used to form the R-Matrix, for each frequency bin.

8. The method of claim 1 wherein the components of the R-Matrix, for each frequency bin, are computed using complex exponentials of the sine of the desired wave mechanics rotation angle, for each frequency bin.

9. The method of claim 1 wherein Rₓₓh=V, using a direct matrix inversion approach or a genetic algorithm to obtain the set of weights, h, for each frequency bin, will solve for the R-matrix, for each frequency bin.

10. The method of claim 1 wherein no estimation or computation of the incident signal Angle of Arrival (AOA) is required, and is therefore effectively blind.

11. The method of claim 1 which can be utilized for any multiplicity of M antennas or sensors and any N far field or near field points.

12. The method of claim 1 wherein the wideband frequency response is produced for a wideband desired input signal and the wavefront for the wideband signal is rotated or shaped in either the near field or the far field.

13. The method of claim 1 wherein the wave mechanics technique is used to compute, from a multiplicity of (M) RF antennas or acoustic transducers, and a collection of points in the far field or near field, a single set of M complex weights, h, for each frequency bin in a Discrete Fourier Transform (DFT) of the original signal.

14. The method of claim 1 wherein the far field wave is able, for a wideband signal, to be manipulated such that the impinging wavefronts at the target or receive antenna or array, are not orthogonal, or perpendicular, to the direction of propagation enabling rotation of the far field or near field wavefront as well as shaping of the wave front.

15. The method of claim 1 wherein the time domain signal model is extended to the Wideband Signal domain, and uses a Discrete Fourier Transform (DFT) to compute the array weights, independently for each frequency bin, and then the set of N frequency weight vectors are used in an inverse Fourier Transform to produce a radiating time domain wideband signal which is constructed for a phased array system of M antennas, or transducers; for acoustics, such that the far field wave at a given point is rotated by a predetermined or computed angle, (β), or the wave front is re-shaped, over any wideband signal bandwidth.

16. The method of claim 1 wherein the multiplicity of M antenna elements are each fed by a coherent, in phase, RF converted signal, and the M antennas can be placed on two or more platforms or separated locations, without the need for co-location.

17. The method of claim 1 wherein a source signal generator produces a digital wideband signal that is processed by the DSP processing block, forwarding each antenna signal to the Digital to RF converter block.

18. The method of claim 1 wherein the DFT of the wideband signal is first computed for N frequency bins from N data samples, and uses the narrowband wave mechanics method to compute the R-Matrix, R_{f}, for each frequency bin, whereas R_{f} is computed for each f=0, 1, . . . , N−1 and carrier frequency of the center of the signal, f₀, and the inclusion of carrier frequency center f₀ is important since the wave mechanics technique operates at the carrier frequency level, next a set of weights, h_{f}, is computed for each frequency bin, using either an inverse matrix approach, or genetic algorithm using the R-Matrix and the desired voltage response vector, V_{f}, then the inverse DFT is computed to obtain the time domain signal vector, Wₙ, for each data sample n, via multiplication of the frequency domain signal and the frequency weight h_{f}, from each frequency bin, in which Wₙ is the Inverse DFT for the wideband signal output, fully weighted across all frequencies, and the new time domain signal vector, Wₙ, is fed into each antenna channel, which becomes the output from the Processing (FPGAs) that would be sent to the transmitter (multi-Channel) exciters.

19. The system implementation of claim 1 wherein an incident wideband signal is received through sensors in an array and passed through RF circulators and these RF circulators are situated between the antenna and the transceiver system, functioning to receive the incident wideband signal, quickly computes the received steering weights (vector) for each frequency bin, conjugate the weights, multiply by the complex rotation exponentials, and use the resulting matrix to compute a set of transmit weight, h, for each frequency bin, and uses in inverse DFT to compute the transmitted wideband signal to transmit back to the original source.

20. The system implementation of claim 19, wherein another embodiment would include the use of RF Switches at each antenna in the array instead of an RF circulator at each antenna.
